(19) United States
(12) Patent Application Publication
(10) Pub. No.: US 2009/0210589 A1
(43) Pub. Date: Aug. 20, 2009

(54) Dynamic Vital Product Data Update Based on an Installed Feature Card

(76) Inventors: John S. Horvath, Rochester, MN (US); Steven P. Norgaard, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 12/032,161

(22) Filed: Feb. 15, 2008

(51) Int. Cl. G06F 13/12

(52) U.S. Cl. 710/62

(57) ABSTRACT

A method, system, and computer program product for dynamically updating vital product data (VPD) based on the presence of an installed feature card supported by an input/output (I/O) adapter in a data processing device. A VPD utility initiates the boot up process of the I/O adapter with the aid of the common boot code in the Boot/VPD segment of a flash module. The hardware configuration registers are loaded with default values. Additionally, the VPD from the (flash) Boot/VPD segment is loaded. When the feature card is present, the VPD utility retrieves configuration information for the feature card and loads the hardware configuration registers with values relevant to the feature card. The VPD utility retrieves the feature card VPD and loads available VPD updates into the (flash) alternate Open Boot segment. The flash firmware image uses the VPD to manage the adapter.

### BACKGROUND

1. Technical Field

The present invention generally relates to data processing systems and in particular to input/output adapter interfaces in data processing systems.

2. Description of the Related Art

An Input/Output (I/O) adapter provides an interface connection for one or more input/output devices to a host computer system. The interface connection may be enhanced with an optional feature card supported by the 1/0 adapter. The feature card is used to provide more functionality/capability in the adapter. An interface connection comprising the I/O adapter without the feature card represents a logically different adapter when compared to a connection comprising the I/O adapter with the feature card.

A typical conventional system may contain an adapter on a planar/motherboard and an optional additional function adapter. This conventional system consists of one or two flash modules, one flash module on the planar and an overriding flash module on the feature card, if present. Additionally, two different sets of VPD/Configuration information may be utilized, with one set located in each flash. In addition, two different firmware images may be utilized, with one firmware image located/stored in each flash. Thus, there is a duplication of components and firmware in the conventional design. When the feature card is present, the processor and memory controller are located on a different card than the flash and the firmware. Consequently, the interface connections provided in conventional systems are less reliable.

### SUMMARY OF ILLUSTRATIVE EMBODIMENTS

Disclosed are a method, system, and computer program product for dynamically updating vital product data (VPD) based on the presence of an installed feature card supported by an input/output (I/O) adapter in a data processing device. A VPD utility initiates the boot up process of the I/O adapter with the aid of the common boot code in the Boot/VPD segment of a flash module. The hardware configuration registers are loaded with default values. Additionally, the VPD from the (flash) Boot/VPD segment is loaded. When the feature card is present, the VPD utility retrieves configuration information of the feature card and loads the hardware configuration registers with values relevant to the feature card. The VPD utility retrieves the feature card VPD and loads available VPD updates into the (flash) alternate Open Boot segment. The flash firmware image uses the VPD to manage the adapter.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram representation of an example data processing system, according to one embodiment of the invention;

FIG. 2 illustrates a system planar comprising an input/output adapter, an adapter feature card and other components of a data processing system, according to one embodiment of the invention; and

FIG. 3 is a flow chart illustrating the process of booting an input/output adapter and updating the vital product data, according to one embodiment of the invention.

### DETAILED DESCRIPTION OF AN ILLUSTRATIVE EMBODIMENT

The illustrative embodiments provide a method, system, and computer program product for dynamically updating vital product data (VPD) based on the presence of an installed feature card supported by an input/output (I/O) adapter in a data processing device. A VPD utility initiates the boot up process of the I/O adapter with the aid of the common boot code in the Boot/VPD segment of a flash module. The hardware configuration registers are loaded with default values. Additionally, the VPD from the (flash) Boot/VPD segment is loaded. When the feature card is present, the VPD utility retrieves configuration information of the feature card and loads the hardware configuration registers with values relevant to the feature card. The VPD utility retrieves the feature card VPD and loads available VPD updates into the (flash) alternate Open Boot segment. The flash firmware image uses the VPD to manage the adapter.

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined only by the appended claims.

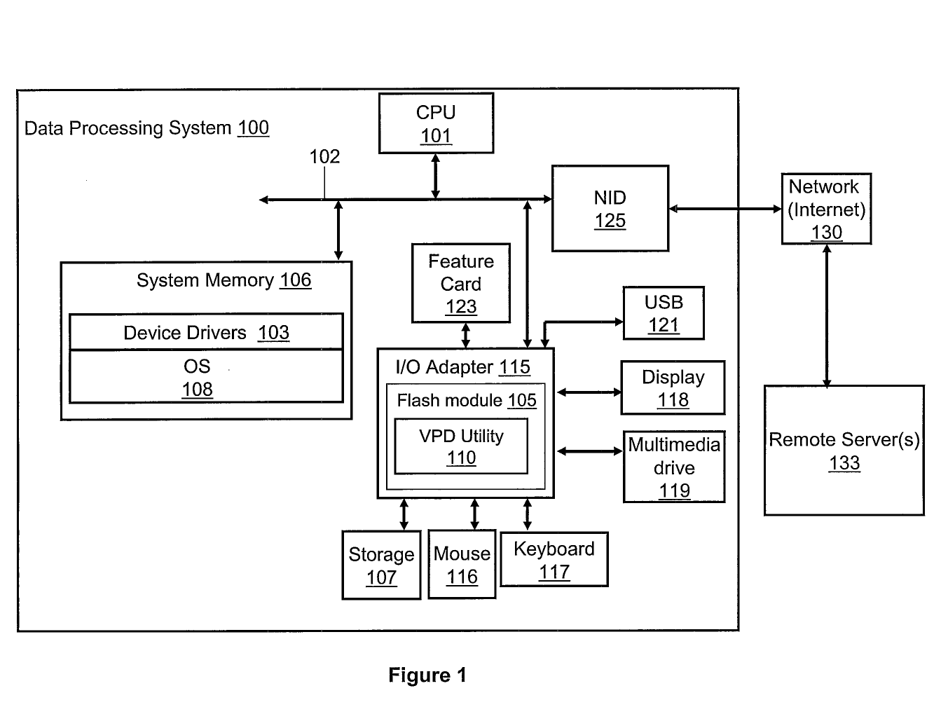

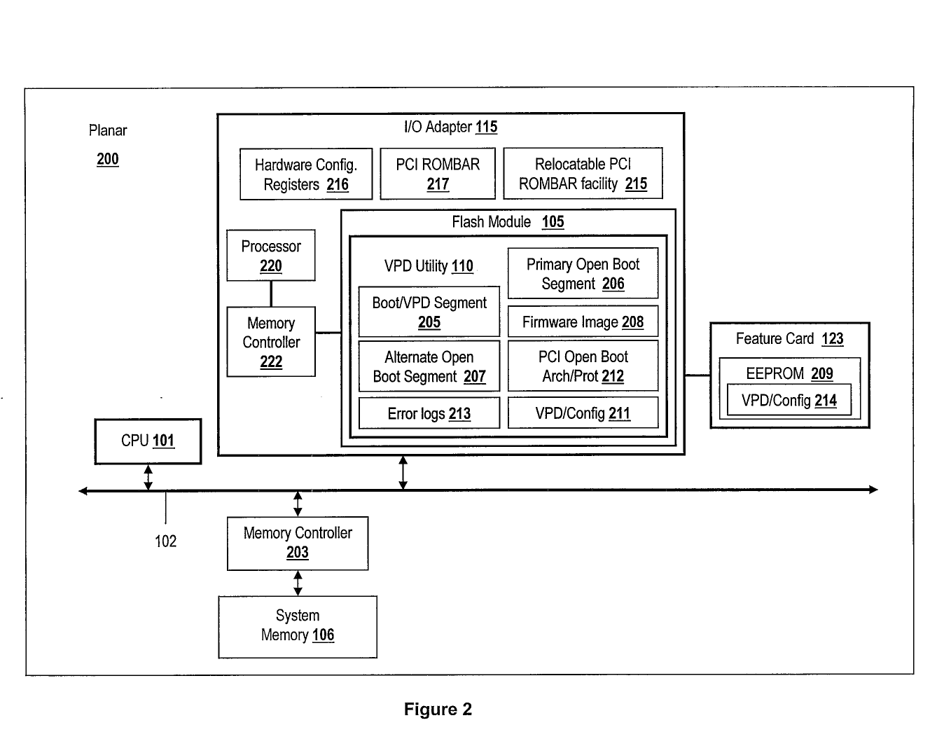

Within the descriptions of the figures, similar elements are provided similar names and reference numerals as those of the previous figure(s). Where a later figure utilizes the element in a different context or with different functionality, the element is provided a different leading numeral representative of the figure number (e.g, 1xx for FIG. 1 and 2xx for FIG. 2). The specific numerals assigned to the elements are provided solely to aid in the description and not meant to imply any limitations (structural or functional) on the invention.

It is understood that the use of specific component, device and/or parameter names are for example only and not meant to imply any limitations on the invention. The invention may thus be implemented with different nomenclature/terminology utilized to describe the components/devices/parameters herein, without limitation. Each term utilized herein is to be given its broadest interpretation given the context in which that terms is utilized.

With reference now to FIG. 1, there is depicted a block diagram representation of a data processing system (and connected network). DPS 100 comprises at least one processor or central processing unit (CPU) 101 connected to system memory 106 via system interconnect/bus 102. Also connected to system bus 102 is I/O adapter 115, which provides connectivity and control for input devices, of which pointing device (or mouse) 116 and keyboard 117 are illustrated, and output devices, of which display 118 is illustrated. I/O adapter 115 is a deep adapter as I/O adapter 115 has the capability to change its operation by loading and running different firmware. Additionally, a multimedia drive 119 (e.g., CDRW or DVD drive) and USB (universal serial bus) hub 121 are illustrated, coupled to I/O adapter 115. Multimedia drive 119 and USB hub 121 may operate as both input and output (storage) mechanisms. I/O adapter 115 further comprises flash module 105. Providing additional functionality/capability in I/O adapter 115 is feature card 123. Feature card 123 is inserted into (or connected to) I/O adapter 115. DPS 100 also comprises storage 107, attached to an I/O adapter 115, within which data/instructions/code may be stored.

DPS 100 is also illustrated with a network interface device (NID) 125, with which DPS 100 connects to one or more servers 133 via access network 130, such as the Internet. In the described embodiments, network 130 is a worldwide collection of networks and gateways that utilize the Transmission Control Protocol/Internet Protocol (TCP/IP) suite of protocols to communicate with one another. Of course, network access may also be provided via a number of different types of networks, such as an intranet, a local area network (LAN), a virtual private network (VPN), or other wide area network (WAN) other than the Internet, for example.

Notably, in addition to the above described hardware components of DPS 100, various features of the invention are completed via software (or firmware) code or logic stored within memory 106 or other storage (e.g., storage 107) and executed by CPU 101. Thus, illustrated within memory 106 are a number of software/firmware components, including operating system (OS) 108 (e.g., Microsoft Windows®, a trademark of Microsoft Corp, GNU®/Linux®, registered trademarks of the Free Software Foundation and Linus Torvalds, or AIX®, a registered trademark of IBM) and device drivers 103. Additionally, vital product data (VPD) utility 110 is included within flash module 105 of I/O adapter 115. VPD utility 110 is the collective name given to a number of software and firmware components which are further described by the illustration of FIG. 2. For simplicity, VPD utility 110 is illustrated and described as a stand alone or separate software/firmware/logic component, which provides specific functions, as described below.

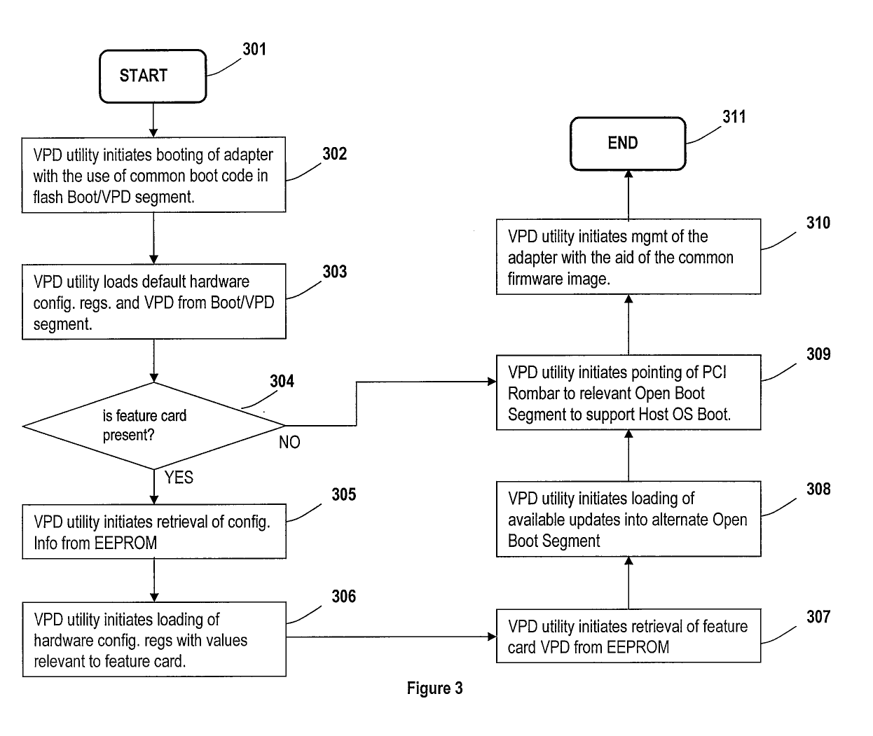

Among the logic/functions provided by VPD utility 110, and which are specific to the invention, are: (a) logic for initiating the booting of an I/O adapter; (b) logic for determining the presence of an adapter feature card; (c) logic for obtaining configuration information from the adapter feature card and loading the hardware configuration registers with values pertaining to the feature card; and (d) logic for obtaining VPD from the adapter feature card and loading the VPD with updates into a specified segment of the flash module. For simplicity of the description, the collective of different logic or functional components that enables these various features is referred to herein as VPD utility 110. According to the illustrative embodiment, when executed, VPD utility 110 enables DPS 100 to initiate a series of functional processes that include the above functional features as well as additional features/functionality, which are described below within the description of FIGS. 2-3.

Those of ordinary skill in the art will appreciate that the hardware and basic configuration depicted in FIG. 1 may vary. For example, other devices/components may be used in addition to or in place of the hardware depicted. The depicted example is not meant to imply architectural limitations with respect to the present invention. The data processing system depicted in FIG. 1 may be, for example, an IBM eServer pSeries system, a product of International Business Machines Corporation in Armonk, N.Y., running the Advanced Interactive Executive (AIX) operating system or LINUX operating system.

With reference now to FIG. 2, a system planar comprising components of a data processing system, is illustrated, according to an illustrative embodiment of the present invention. System planar 200 comprises at least one processor or central processing unit (CPU) 101. System planar 200 also comprises memory 106 and associated memory controller 203 and I/O adapter 115 connected to system bus 102. System planar 200 also comprises hardware configuration registers 216, contained within the I/O adapter 115, within which configuration data may be stored. Additionally, system planar 200 comprises PCI (peripheral component interconnect) ROMBAR (Read only Memory Base Address Register) 217, contained within the I/O adapter 115, within which data pointing to the appropriate Open Boot segment is stored. System planar 200 may represent a printed circuit board and, in particular, a mother-board.

As shown, within I/O adapter 115 is flash module (or flash memory) 105, within which the logic components of VPD utility 110 are located. VPD utility 110 is the collective name given to a particular group of software and firmware or logic components/segments. As further shown, feature card 123 is directly connected to I/O adapter 115. Feature card 123 provides additional functionality/capability in I/O adapter 115.

Flash module 105 consists of several logic components or segments (collectively illustrated as VPD utility 110). The segment layout contains (without limitation) Boot/VPD segment 205, primary Open Boot segment 206, alternate Open Boot segment 207, firmware image 208, VPD/configuration information 211, PCI open boot architecture/protocol 212, and error logs 213 The Open Boot segments (206, 207), one for each logical adapter, must comply with PCI Open Boot architecture/protocol 212 to support the Host OS Boot. The (two) logical adapters are providing for the embodiments in which both I/O adapter 115 is and feature card 123 are present. In the alternate implementation, the I/O adapter 115 is present, while the feature card 123 is not present.

Relocatable PCI ROMBAR facility 215 within I/O adapter 115 is utilized to present the correct Open Boot segment to the Host. Relocatable PCI ROMBAR facility 215 may also be used by a Host Device Driver (103. FIG. 1) to read other flash segments such as persistent error logs (213). Feature card 123 also includes serial electrically erasable programmable read only memory (EEPROM) 209 which further comprises VPD/Configuration information 214.

The illustrative embodiment, which provides a consistent adapter interface for a host system, comprises a single flash module (105) on planar 200 and serial EPROM 209 on feature card 123. A (single) firmware image (208) resides in flash module 105. Flash module 105, with firmware 208 resides on the same board as the adapter processor (101) and memory controller 203, with or without feature card 123 attached. There are two copies of VPD/Configuration information (211, 214) in persistent storage (i.e., in flash 105 and in serial EEPROM 209, respectively). Adapter 115 changes functional characteristics based on external stimulus (i.e., provided by the presence of feature card 123). Adapter VPD/configuration information is updated automatically at Boot time. A further description of the process for booting adapter 115 is illustrated by FIG. 3, which is described below.

FIG. 3 is a flow chart illustrating a method by which the above processes of the illustrative embodiments are completed. Although the methods illustrated in FIG. 3 may be described with reference to components shown in FIGS. 1-2, it should be understood that this is merely for convenience and alternative components and/or configurations thereof can be employed when implementing the various methods. Key portions of the methods may be completed by VPD utility 110 (FIG. 1 and 2) controlling specific operations of/on DPS 100, and the methods are thus described from the perspective of either/both VPD utility 110 and DPS 100 with respect to the I/O adapter 115

The process of FIG. 3 begins at initiator block 301 and proceeds to block 302, at which VPD utility 110 initiates the booting of the Input/Output (I/O) adapter with the aid of the common boot code in the Boot/VPD segment of the single flash module. At block 303, VPD utility 110 loads the default hardware configuration registers and the VPD from the (flash) Boot/VPD segment. At decision block 304, VPD utility 110 determines whether the feature card is present. If at block 304 VPD utility 110 determines that the feature card is not present, the process proceeds to block 309. If VPD utility 110 determines that the feature card is present, the process enters block 305, at which, VPD utility 110 initiates the retrieval of the configuration information from the 12C Serial EEPROM. VPD utility 110 initiates the loading of the hardware configuration registers with values relevant to the feature card, as shown at block 306. At block 307, VPD utility 110 initiates the retrieval of the feature card VPD from the EEPROM. VPD utility 110 also initiates the loading of available updates to the VPD into the alternate Open Boot segment, as shown at block 308. At block 309, VPD utility 110 initiates the pointing of PCI ROMBAR to the relevant Open Boot Segment to support the operating system (OS) boot process of the host device. VPD utility 110 initiates the management of the adapter with the aid of the flash firmware image, as shown at block 310. Furthermore, the flash firmware image uses VPD-based parameterization to determine the correct adapter behavior. Following, the initiation of the management of the adapter with the aid of the flash firmware image, the process ends at block 311.

In the flow charts above, one or more of the methods are embodied as a computer program product in a computer readable medium or containing computer readable code such that a series of steps are performed when the computer readable code is executed on a computing device. In some implementations, certain steps of the methods are combined, performed simultaneously or in a different order, or perhaps omitted, without deviating from the spirit and scope of the invention. Thus, while the method steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

As will be further appreciated, the processes in embodiments of the present invention may be implemented using any combination of software, firmware or hardware. As a preparatory step to practicing the invention in software, the programming code (whether software or firmware) will typically be stored in one or more machine readable storage mediums such as fixed (hard) drives, diskettes, optical disks, magnetic tape, semiconductor memories such as ROMs, PROMs, etc., thereby making an article of manufacture (or computer program product) in accordance with the invention. The article of manufacture containing the programming code is used by either executing the code directly from the storage device, by copying the code from the storage device into another storage device such as a hard disk, RAM, etc., or by transmitting the code for remote execution using transmission type media such as digital and analog communication links. The methods of the invention may be practiced by combining one or more machine-readable storage devices containing the code according to the present invention with appropriate processing hardware to execute the code contained therein. An apparatus for practicing the invention could be one or more processing devices and storage systems containing or having network access to program(s) coded in accordance with the invention.

Thus, it is important that while an illustrative embodiment of the present invention is described in the context of a fully functional computer (server) system with installed (or executed) software, those skilled in the art will appreciate that the software aspects of an illustrative embodiment of the present invention are capable of being distributed as a computer program product in a variety of forms, and that an illustrative embodiment of the present invention applies equally regardless of the particular type of media used to actually carry out the distribution. By way of example, a non exclusive list of types of media, includes recordable type (tangible) media such as floppy disks, thumb drives, hard disk drives, CD ROMs, DVDs, and transmission type media such as digital and analogue communication links.

While the invention has been described with reference to exemplary embodiments, it will be understood by those skilled in the art that various changes may be made and equivalents may be substituted for elements thereof without departing from the scope of the invention. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. In a data processing device comprising an input/output adapter and an adapter feature card, a method comprising:
initiating booting of the input/output (I/O) adapter utilizing boot code stored in a first segment of a flash memory, wherein said adapter and said flash memory reside on a same circuit board;
loading one or more hardware configuration registers with default values;
loading vital product data from the first segment of the memory, wherein one or more segments of said memory comply with a peripheral component interconnect (PCI) Open Boot architecture/protocol;
determining when the adapter feature card is present on the same circuit board as the adapter; and
in response to the feature card being present:
(1) retrieving configuration information for the adapter feature card;
(2) loading the one or more hardware configuration registers with values corresponding with the adapter feature card, based on the retrieved configuration information; and
(3) obtaining a second set of vital product data from storage on the adapter feature card;
wherein the VPD is automatically updated whenever the adapter feature card is present.

2. The method of claim 1 further comprising:
in response to the feature card being present:
(1) loading one or more available updates to the vital product data into a second segment of the memory;
(2) pointing a PCI read only memory base address register (ROMBAR) to a particular segment of memory which contains relevant data, utilizing a relocatable PCI ROMBAR facility, wherein said relevant data facilitates an operating system boot process of the device; and
(3) managing the adapter via a firmware image stored within the memory.

3. The method of claim 2 wherein:
said relocatable PCI ROMBAR facility enables a device driver to read a set of error logs located in a third segment of the memory.

4. A data processing system comprising:
a processor;
an input/output (I/O) adapter coupled to the processor via a system bus;
one or more hardware configuration registers;
a relocatable PCI ROMBAR facility;
an adapter feature card coupled to the I/O adapter;
a flash module/memory associated with the I/O adapter and which includes a utility having logic for providing the functionality of:
initiating booting of the input/output (I/O) adapter utilizing boot code stored in a first segment of a flash memory, wherein said adapter and said flash memory reside on a same circuit board;
loading one or more hardware configuration registers with default values;
loading vital product data from the first segment of the memory, wherein one or more segments of said memory comply with a peripheral component interconnect (PCI) Open Boot architecture/protocol;
determining when the adapter feature card is present on the same circuit board as the adapter; and
in response to the feature card being present:
(1) retrieving configuration information for the adapter feature card;
(2) loading the one or more hardware configuration registers with values corresponding with the adapter feature card, based on the retrieved configuration information; and
(3) obtaining a second set of vital product data from storage on the adapter feature card;
wherein the VPD is automatically updated whenever the adapter feature card is present.

5. The system of claim 4, wherein said utility further comprises logic for:
in response to the feature card being present:
(1) loading one or more available updates to the vital product data into a second segment of the memory;
(2) pointing a PCI read only memory base address register (ROMBAR) to a particular segment of memory which contains relevant data, utilizing a relocatable PCI ROMBAR facility, wherein said relevant data facilitates an operating system boot process of the device; and
(3) managing the adapter via a firmware image stored within the memory.

6. The system of claim 5 wherein said relocatable PCI ROMBAR facility enables a device driver to read a set of error logs located in a third segment of the memory.

7. A computer program product comprising:
a computer readable medium; and
program code on said computer readable medium that when executed within a data processing device, said program code provides the functionality of:
initiating booting of the input/output (I/O) adapter utilizing boot code stored in a first segment of a flash memory, wherein said adapter and said flash memory reside on a same circuit board;
loading one or more hardware configuration registers with default values;
loading vital product data from the first segment of the memory, wherein one or more segments of said memory comply with a peripheral component interconnect (PCI) Open Boot architecture/protocol;
determining when the adapter feature card is present on the same circuit board as the adapter; and
in response to the feature card being present:
(1) retrieving configuration information for the adapter feature card;
(2) loading the one or more hardware configuration registers with values corresponding with the adapter feature card, based on the retrieved configuration information; and
(3) obtaining a second set of vital product data from storage on the adapter feature card;
wherein the VPD is automatically updated whenever the adapter feature card is present.

8. The computer program product of claim 7, further comprising program code for:
in response to the feature card being present:
(1) loading one or more available updates to the vital product data into a second segment of the memory;
(2) pointing a PCI read only memory base address register (ROMBAR) to a particular segment of memory which contains relevant data, utilizing a relocatable PCI ROMBAR facility, wherein said relevant data facilitates an operating system boot process of the device; and
(3) managing the adapter via a firmware image stored within the memory.

9. The computer program product of claim 8 wherein said relocatable PCI ROMBAR facility enables a device driver to read a set of error logs located in a third segment of the memory.
